(19) United States
(12) Patent Application Publication
(10) Pub. No.: US 2023/0063636 A1
(43) Pub. Date: Mar. 2, 2023

(54) TRACTION BATTERIES WITH SOLID-STATE CELLS AND SHAPE-MEMORY ALLOYS

(71) Applicant: FORD GLOBAL TECHNOLOGIES, LLC, Dearborn, MI (US)

(72) Inventors: Asma Sharafi, Ann Arbor, MI (US); Andrew Robert Drews, Ann Arbor, MI (US)

(21) Appl. No.: 17/460,839

(22) Filed: Aug. 30, 2021

(51) Int. Cl. H01M 10/0562; H01M 10/0525; H01M 50/204; H01M 4/66; H01M 10/04; H01M 10/0585

(52) U.S. Cl. CPC H01M 10/0562; H01M 10/0525; H01M 50/204; H01M 4/662; H01M 10/0468; H01M 10/0585; H01M 2220/20; H01M 2300/0065

(57) ABSTRACT

A traction battery includes a plurality of solid-state-battery cells arranged in a stack, a pair of endplates engaging with opposing ends of the stack and configured to generate a predetermined magnitude of stack pressure in the stack, and a plate of shape-memory alloy disposed in the stack. The plate of shape-memory alloy is configured to expand or contract in thickness responsive to volume changes within the battery cells to maintain the stack pressure within a range of the predetermined magnitude.

### TECHNICAL FIELD

This disclosure relates to solid-state batteries and more particularly to traction batteries having solid-state battery cells and shape-memory alloys.

### BACKGROUND

A vehicle powertrain may include one or more electric machines used to propel the vehicle. The electric machines may be sole power source of the powertrain or may be used in conjunction with an internal combustion engine. The electric machines are powered by a traction battery. The traction battery may include a plurality of battery cells that are connected in series, parallel, or combinations thereof. One type of battery cells is a solid-state battery.

### SUMMARY

According to one embodiment, a solid-state battery cell includes an outer case and one or more mono-cells disposed in the case. The mono-cell includes a cathode, an anode, a solid-state electrolyte sandwiched between the cathode and the anode, and a current collector associated with the one of a cathode or anode. The current collector has a plate of shape-memory alloy disposed against an outer side of the one of the cathode or anode, wherein the plate of shape-memory alloy is configured to expand or contract in thickness responsive to a change in pressure within an interior of the outer case.

According to another embodiment, a traction battery includes a plurality of solid-state-battery cells arranged in a stack, a pair of endplates engaging with opposing ends of the stack and configured to generate a predetermined magnitude of stack pressure in the stack, and a plate of shape-memory alloy disposed in the stack. The plate of shape-memory alloy is configured to expand or contract in thickness responsive to volume changes within the battery cells to maintain the stack pressure within a range of the predetermined magnitude.

According to one embodiment, a battery array including a plurality of battery cells arranged in a stack with each including an anode, a cathode, and a solid-state electrode. A pair of endplates are configured to compress the stack to a predetermined stack pressure. A plate of shape-memory alloy is disposed in the stack and is configured to expand or contract responsive to a volume change of the anode, the cathode, or both to maintain the predetermined stack pressure within a predetermined range.

### BRIEF DESCRIPTION OF THE DRAWINGS

FIG. 1 is a schematic diagram, in cross section, of a mono-cell according to one or more embodiments present disclosure.

FIG. 2 is a schematic diagram, in cross section, of a mono-cell stack according to one or more embodiments of the present disclosure.

FIG. 3 is a diagrammatical exploded view of a battery cell according to one or more embodiments of the present disclosure.

FIG. 4 is a perspective view of a traction battery according to one or more embodiments of the present disclosure.

FIG. 5 is a diagrammatical side view of a battery array according to one or more embodiments of the present disclosure.

FIG. 6 is a schematic diagram of an example hybrid vehicle according to one or more embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except where expressly indicated, all numerical quantities in this description indicating amounts of material or conditions of reaction and/or use are to be understood as modified by the word “about” in describing the broadest scope of the present invention.

The description of a group or class of materials as suitable for a given purpose in connection with one or more embodiments of the present invention implies that mixtures of any two or more of the members of the group or class are suitable. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

A solid-state battery (SSB) may have both solid electrodes and solid electrolyte. The solid-state battery cells may be based on ceramic electrolytes, polymer based electrolyte, polymer composites and crystalline, and glassy sulfide as well as oxide ceramic materials. SSBs can improve volumetric energy density over conventional lithium-ion batteries. But the implementation of current solid state batteries is challenging due to the limited conductivity of solid electrolytes and several competing factors such as a need for a low cell resistance and good mechanical robustness. One technical challenge of SSBs is the poor stability of the interface(s) between the anode and/or cathode and the solid electrolyte.

Although low resistance is observed with lithium/solid electrolyte interface in an as-fabricated or newly fabricated SSB, the resistance may increases significantly with cycle life. The increased resistance causes degradation in the rate capability and capacity of the SSB. This issue can be the result of mechanical stresses at the interface as well as due to non-uniform plating and stripping of lithium metal, which occurs during the cycling process. These factors may lead to a poor contact between the solid electrolyte and the lithium metal anode/cathode, which increases the resistance. Other challenges include high interface impedance and confinement effects that arise due to the volume changes of active materials during cycling. Volume changes of the cathode during lithiation and delithiation generate stresses and voids, which may deform and expose the fresh SE to the cathode surface. This may initiate chemical and electrochemical decomposition and further increase the cathodic charge transfer resistance.

A SSB system architecture may contain a lithium (Li) metal or an anode composite or Li free, a cathode composite and a solid-state electrolyte (SSE) that separate the electrode materials. In general, chemo-mechanical phenomena can manifest more acutely in solid-state systems compared to conventional liquid electrolyte-based batteries. This is because stress and strain can be transmitted more effectively in solid-state systems, whereas liquid electrolytes in conventional batteries cannot sustain shear stress or strain and thus act to relieve electrochemically induced strain.

Electrode composites in SSBs featuring densified mixtures of active material particles within SSE materials may exhibit complex chemo-mechanics where even very small strains experienced in active materials due to Li⁺ ion transport (lithiation and delithiation during cycling) can be transmitted across the interface and mechanically stress the SSE, which subsequently inhibits ion transport. Furthermore, Li metal electrodeposition and ion insertions on the Li metal anode side can also induce mechanical stress at an interface. During Li deposition on the Lithium side, compared to the pristine (fabricated) Li metal, the deposited Li metal layer is less dense. Thus, the volume of a lithium metal anode after full charge is larger than its pristine volume because of the deposition of a loosely packed lithium metal layer. This substantial volume change of the lithium metal anode can urge delamination between the lithium metal anode and SSE, inducing high interfacial impedance and negatively effecting cell performance.

The active materials can be mechanically deformed as due to ion insertion and extraction. The volume change caused by this phenomenon may stress the matrix, and in extreme cases, can cause delamination at the interface and result in reduced battery performance. In addition, the morphological evolution of the Li metal anode during stripping, more specifically the pore formation within Li metal at the interface with SSE, can cause dynamic changes at the interfacial contact and as a consequent adversely affect the interfacial impedance. These phenomena have delayed wide-spread commercial implementation of SSB in electric vehicles and other applications. Thus, it is necessary to address the challenges related to the effects of chemical and morphological evolution and mechanical stress/strain at interface with the SSE to enable implementation of SSBs in applications such as electric vehicles.

One challenge in maintaining the mechanical contact in the cathode composite is due to the volume change of the cathode materials during cycling. The volume changes of up to 8 percent, for example, are possible for cathode materials during cycling. Due to the small elastic deformation of SSEs in the cathode composite, one way to accommodate the volume change in cathode particles is through displacement of particles in composites. Several routes can be envisioned to improve the mechanical response of the cathode composite and anode interface including the optimization of cathode morphology, cathode chemistry/structure, mechanical properties of SSE and the use of external pressure. In order to enhance the cycle performance of SSBs, the technique of stack pressure application may be employed, in which the uniaxial stack pressure (such as 35-400 MPa for example) is applied to buffer the volume change of the SSBs during Li insertion and extraction processes so that the electrode integrity and electronic contact between active materials and SSE particles are maintained. The application of stack pressure may improve the cycling behavior of SSBs since it eliminates the contact loss in the composite cathode that could lead to increased interfacial resistance. Contact loss during cycling may occur at the anode side as well. The anode-SSE interfacial impedance increases significantly during cycling and decreases by application of pressure. This phenomenon suggests that anode delamination can exist at the anode interface and the application of pressure may improve the anode morphology and the contact at this interface. Application of a large external pressure (stack pressure) during cycling, in principle, can reduced the contact loss at the cathode- or anode-SSE interface, however, a practical application for applying such high pressure has been elusive.

Disclosed herein is a novel approach in which a shape-memory alloy (SMA) is used as a buffer so that the capacity decay in SSBs can be avoided. SMA exhibit superelasticity based on their stress-induced martensitic transformation (SIMT) in which a very large strain can be achieved and recovered by loading and unloading, respectively. For this reason, SMIT and the resultant superelasticity of SMA can be employed to accommodate the volume change and stress of cathode composites and anode materials in SSBs. The phase transformation may be induced by the stress during the volume expansion of active cathode materials in cathode composites during discharge (cathode lithiation), and the transformed phase will go back to its original phase as the stress is released due to the delithiation of cathode materials and the reversal of the volume expansion of the cathode composite. In such a manner, the large expansion and internal stress during the Li insertion and extraction can be accommodated and constrained to mitigate risks of delamination of particles. Thus, the capacity decay during cycling can be reduced. To overcome the capacity decay of the cathode composites due to volume change and particle delamination by superelasticity of the SMA, the SIMT is induced by the stress generated from the volume expansion associated with the cathode lithiation.

For SMA, the stress required to induce the martensitic transformation is normally small and depends on the difference between the applied temperature and temperature for martensitic phase transformation (Mₛ), which can be expressed in Clausius-Clapeyron type equation:

$$\frac{d {σ}_{m}}{dT} = \frac{- Δ H ρ}{Δ ε {T}_{eq}}$$

where Δε is the linear strain of the transformation under uniaxial stress (σₘ), which can be represented by maximum recovery strain of martensitic transformation (˜8%), ΔH is the enthalpy of phase transformation and ρ is the density of the SMA. By integration the following equation is obtained:

$$( {σ}_{M} - {σ}_{0} ) = \frac{- Δ H ρ}{Δ ε} ln ( \frac{T}{{T}_{0}} )$$

where σ₀ and T₀ are the reference stress and temperature, respectively. Taking Δε=8% (example maximum recovery strain in example SMA alloy, such as NiTi foran), T₀=18.2° C. and σ₀ is zero,

$$Δ H ρ = - 1.39 \frac{J}{g}$$

for the martensitic transformation, density of NiTi is 6.45 g/cm³, σₘ is determined to be 35.5 MPa at room temperature. (This of course, is just one example.)

Furthermore, the elastic-strain energy that accompanies Li-compound formation in the lithiation process can be evaluated via the use of micromechanics theory based on Eshelby's ellipsoidal inclusion theory. In this theory, an isolated spherical inclusion of the Li compound (i.e., cathode active material) is assumed to be formed in an elastically isotropic matrix (i.e., SSE material). Wherein, ε* represents the average eigenstrain (stress-free transformation strain such as phase transformation strains), σ is the stress and γ is the total strains determined from the volume expansion during cathode or anode lithiation.

$${ε}^{*} = ( \sqrt[3]{{V}_{I}} - \sqrt[3]{{V}_{m}} ) / \sqrt[3]{{V}_{m}} \\ γ = S {ε}^{*} \\ σ = E γ$$

where Vₘ and V_{I} represent the volume per mole of the active materials before and after lithiation, E is the elastic constant of active material, and S is the Eshelby tensor

$$( S = \frac{7 - 5 v}{15 ( 1 - v )}$$

where ν is the possion's ratio of the matrix SSE material in this case).

In one example, consider lithium cobalt oxide as cathode active material and garnet lithium lanthanum zirconium oxide (LLZO) as SSE material, wherein Vₘ (CoO)=11.63 cm³/mole, V_{I} (LiCoO₂)=20.43 cm³/mole, S=0.51, E=191 GPa:

$${ε}^{*} = ( \sqrt[3]{{V}_{CoO 2}} - \sqrt[3]{{V}_{LiCoO 2}} ) / \sqrt[3]{{V}_{Li 2 CoO 2}} = 0.2 \\ γ = S {ε}^{*} = 0.51 * 0.2 = 0.1 \\ σ = E γ = 191 * 0.1 = 19.1 GPa$$

According to the calculation above for the LCO cathode active material, the stress induced by lithiation process can be estimated to be 19.1 GPa. σₘ is determined to be about 35.5 MPs for the NiTi SMA at room temperature. This shows estimated critical stress (σₘ) is much lower than that generated stress from the lithiation transition in the cathode active material and suggests that the stress generated from the volume expansion of the cathode active material layer can induce the martensitic transformation in the SMA layer. The same applies for the anode side employing anode materials including anode composites, Li metal or other type of metal anodes such Sn.

Based on the discussion above, it is established that the SMA can be used to accommodate the stress and strain resulting from the Li insertion in the active materials in SSBs and in turn enhance the cycle life of the SSBs. It should be noted that the martensitic transformation can be employed by temperature as well to realize the phase transformation of SMA. The starting temperature for martensitic phase transformation (Mₛ) of SMA should be lower than the temperature of the working battery so that martensite does not form in the SMA layer at room temperature without external stress.

To implement the SMA in the solid-state battery cells and address the challenges mentioned above, a cell stack approach is disclosed that uses one or more SMA sheets as one or more components of a battery cell array. Examples include SMA current collectors, thin sheet layer(s) incorporated in the battery cell, and as spacers or end plates of a cell stack in a battery array. The sheets may provide uniform, flat surfaces for sealing. In the case of pouch-type cells, the pouch thickness may be higher for incorporation of SMA sheets to aid with accommodating the stress and strain during cycling. The SMA can be used as the pouch material if the material is unreactive with the other battery-cell components and is electrically non-conductive.

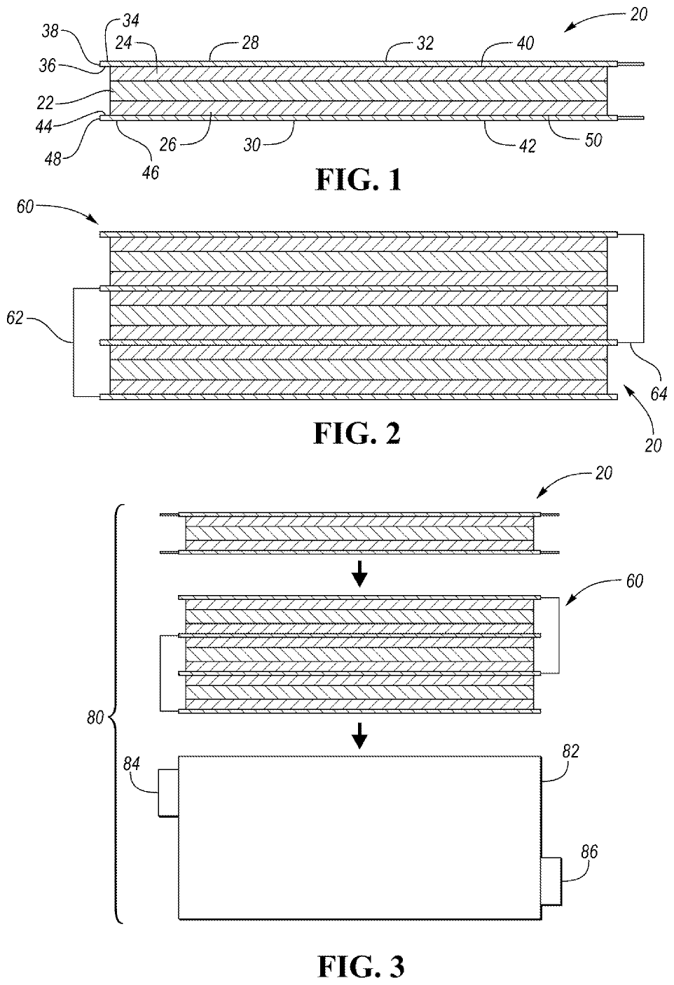

Referring to FIG. 1, a mono-cell 20, i.e., a single cell, includes a solid-state electrolyte 22 sandwiched between a negative electrode 24 (cathode) and a positive electrode 26 (anode). The mono-cell may be lithium-ion. Example materials of the cathode 24 include lithium cobalt oxide (LCO), lithium nickel manganese cobalt oxide (NMC), lithium nickel cobalt oxide doped with alumina (NCA), lithium manganese oxide (LMO), and lithium iron phosphate (LFP), conversion cathode (metal oxides), and sulfur. Example materials of the anode 26 include graphite, Li metal, Si, SiOx, Si/C composite, Li free.

The cathode 24 includes a first side that is disposed against the solid-state electrolyte 22 and a second side that is disposed against a negative current collector 28. The anode 26 includes a first side that is disposed against the solid-state electrolyte 22 and a second side that is disposed against a positive current collector 30.

One or both of the current collectors 28/30 may be formed of a sheet or plate of a shape-memory alloy that is electrically conductive. Example SMAs include NiTi (53-57 wt. % Ni), Nitinol, Ag—Cd, Au—Cd, Cu-AI-Ni Cu—Sn, Cu—Zn, Cu—Zn—X (X═Si, Sn, AI), In— Ni-AI, Ni—Ti, Fe—Pt, Mn—Cu, Fe—Mn—Si, CuZnAl, and others.

In one embodiment, the negative current collector 28 is (or includes) a plate 32 of shape-memory alloy. The plate 32 may be generally planar with large major sides 34, 36 and thin edges 38. The inner major side 34 is disposed against the second side of cathode 24 along an interface 40. As discussed above, the properties of the shape-memory alloy maintain the mechanical connection at the interface to provide a robust solid-state battery. The positive current collector 30 may also be (or include) a plate 42 of shape-memory alloy. The plate 42 may be generally planar with large major sides 44, 46 and thin edges 48. The inner major side 44 is disposed against the second side of anode 26 along an interface 50. Again, the properties of the shape-memory alloy maintain the mechanical connection at the interface 50 to provide a robust solid-state battery.

The mono-cell 20 of the present disclosure may include a variety of materials. For example, the mono-cell include materials such as Ag4RbI5 for Ag+ conduction, various oxide-based electrolytes such as lithium lanthanum zirconium oxide (LLZO), lithium phosporhus oxynitride (LiPON), LATP, LISICON, Thio-LISICON, etc. and sulfide-based electrolytes such as Li10GeP2S12, Li2S—P2S5, etc. for Li+ conduction, a clay and β-alumina group of compounds (NaAl11O17) for Na+ conduction and other mono- and divalent ions. The mono-cell 20 cathode, anode, or both may be free of lithium (Li) ions at least at one point of formation, while the mono-cell 20 is in its as-assembled state, or during operation of the battery.

Referring to FIG. 2, a plurality of mono-cells 20 may be arranged to form a stack 60. The mono-cells 28 may be stacked with the major faces disposed against each other. In the illustrated example, the stack 60 includes three mono-cells 20. In this design, some of the current collectors are shared between adjacent mono-cells, however, this need not be the case. The positive current collectors may be connected to each other by a conductor 62, and the negative current collectors may be connected to each other by a conductor 64. The number of mono-cells 20 in the stack 60 will vary and FIG. 2 is just an example.

FIG. 3 illustrates an exploded diagrammatical view of an example pouch-type solid-state battery cell 80. The battery cell 80 includes the stack 60 arranged within the pouch or outer case 82. The pouch 82 may be formed of an insulating material. The battery cell 80 also includes terminals such as a positive terminal 84 and a negative terminal 86. The positive terminal 84 is electrically connected to the positive current collectors of the mono-cells 28, and the negative terminal 86 is electrically connected to the negative current collectors of the mono-cell 28. The pouch-type battery cell 80 is merely one example and other types of cells may be used such as a prismatic or cylindrical battery cells. In cylindrical cells, the stack 60 may be rolled rather than arranged in a linear stack is shown in FIG. 2.

Forming the current collector of shape-memory alloy is but one example embodiment. Alternatively, a plate of shape-memory alloy may be attached to an end of the stack, i.e., a plate of shape-memory alloy may be attached on an outside surface of one of the current collectors. The plate of shape-memory alloy may also be placed between adjacent mono-cells rather than being placed on the outside of the stack.

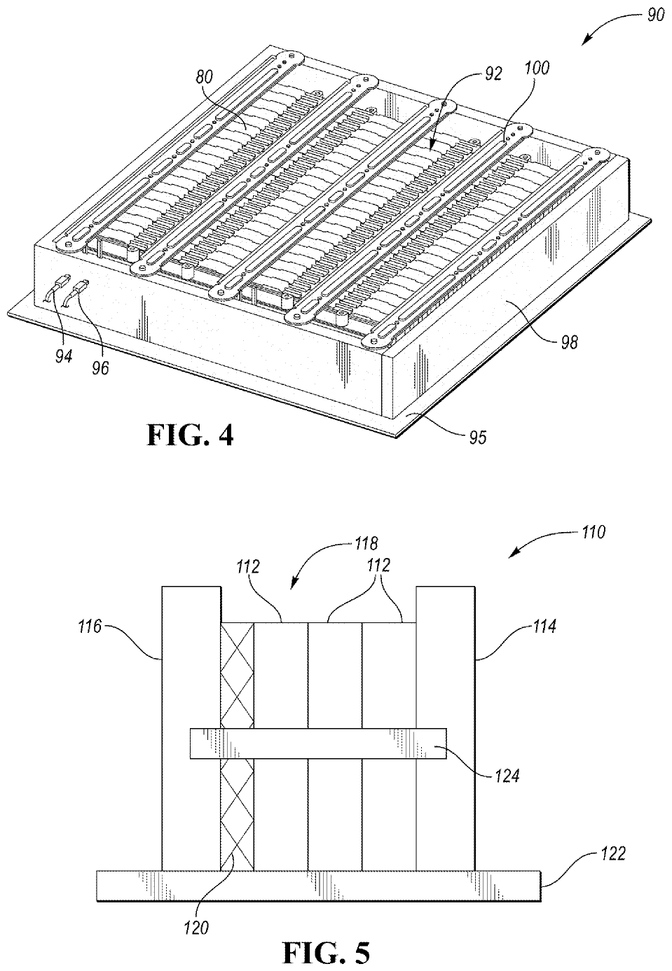

FIG. 4 illustrates an example traction battery 90 that includes a plurality of battery cells 80 arranged in one or more arrays 92. Each array 92 includes a plurality of battery cells that are electrically connected in series, parallel, or combinations thereof within the array. In the illustrated embodiment, the arrays 92 are linear stacks of the pouch-type solid-state battery cells 80. In other embodiments, the arrays 92 may be formed of a plurality of prismatic or cylindrical cells. The battery arrays 92 are electrically connected to each other in series, parallel, or combinations thereof. The battery 90 includes a positive terminal 94 and a negative terminal 96 that are electrically connected to the battery arrays 92. The terminals 94, 96 are electrically connected to the high-voltage bus of the electric powertrain. The traction battery 90 may include a tray 94 that supports the battery arrays 92. Sidewalls 98 may extend upward from the tray 94. Additional brackets 100 and other support structure may be used to secure the arrays in place. A battery cover (not shown) may be connected on the tops of the sidewalls 98 to fully enclose the traction battery and its associated electronics.

The cells 80 within each array 92 may be compressed, i.e. the stack is compressed to have a stack pressure. Each array may include a pair of opposing endplates that exert a normal force on the ends of the cell stacks to compress the battery cells 80. Each array may have an ideal or designed stack pressure or range of stacked pressures. As explained above, the battery cells 80 expand and contract during cycling. Contraction of the cells reduces the stack pressure and expansion of the cells increases the stack pressure. Also as explained above, the ideal range of stacked pressures for solid-state batteries is more sensitive than with traditional liquid electrolyte batteries. By including the shape-memory alloys within the cells 80, the natural expansion and contraction of the cathode/anode/solid-state electrolyte can be accounted for by a volume change in the shape-memory alloy. As such the shape-memory alloy can maintain the pressure within the arrays 92 within an acceptable range. That is, the shape-memory alloy can expand roughly equal to the contraction of the battery cell to maintain a desired stack pressure during discharge. Conversely, the shape-memory alloy can contract roughly equal to the expansion of the battery cell during charge to maintain the desired stack pressure.

FIG. 5 illustrates an alternative embodiment in which the shape-memory alloys are not disposed within the battery cell but rather are placed in the array stack. For example, a cell array 110 includes a plurality of battery cells 112 arranged in a linear stack 118 between a pair of endplates 114 and 116. The shown stack includes three cells for illustrative purposes but may include dozens or hundreds of cells. The stack includes one or more plates or spacers 120 of shape-memory alloy. The shown cell array 110 only includes a single spacer 120 but in other embodiments, multiple shape-memory alloy plates or spacers 120 may be included in the stack 118.

The endplates 116 and 114 are configured to compress the stack 118. The compression may occur by attaching the endplates to a substrate 122 in such a manner that the endplates apply a force to the ends of stack. One or more brackets 124 may be used to maintain the position of the endplates relative to each other. The shape-memory alloy 120 is configured to expand and contract in concert with the expansion and contraction of the battery cells 122 maintain the stack pressure within a desired range as described above.

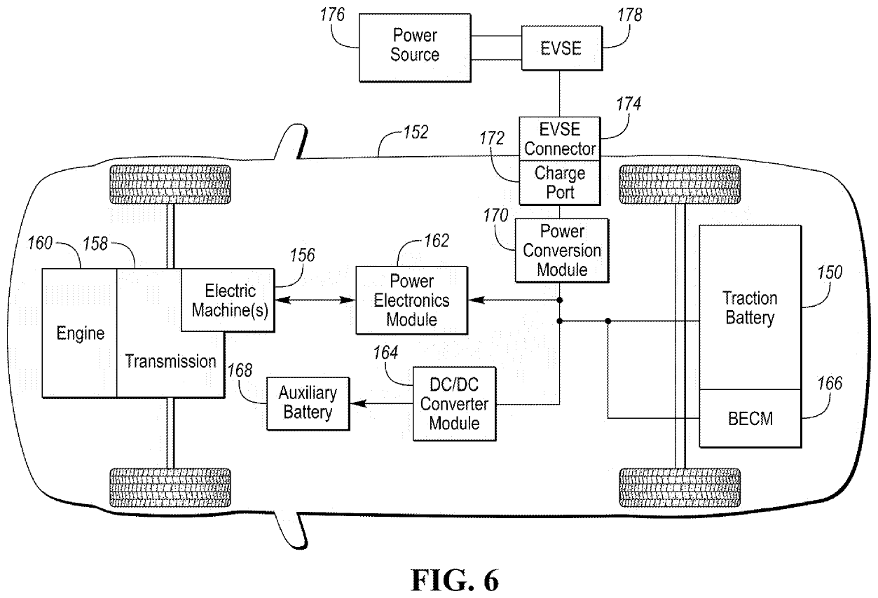

Referring to FIG. 6, a traction battery 150, according to one or more of the above described solid-state battery arrangements, may be used to power an electric vehicle 152. FIG. 5 depicts a schematic of a typical plug-in hybrid-electric vehicle (PHEV). Certain embodiments, however, may also be implemented within the context of non-plug-in hybrids and fully electric vehicles. The vehicle 152 includes one or more electric machines 156 mechanically connected to a hybrid transmission 158. The electric machines 156 may be capable of operating as a motor or a generator. In addition, the hybrid transmission 158 may be mechanically connected to an engine 160. The hybrid transmission 158 may also be mechanically connected to a drive shaft that is mechanically connected to the wheels. The electric machines 156 can provide propulsion and deceleration capability when the engine 160 is turned on or off. The electric machines 156 also act as generators and can provide fuel economy benefits by recovering energy through regenerative braking. The electric machines 156 reduce pollutant emissions and increase fuel economy by reducing the workload of the engine 160.

The traction battery or battery pack 150 stores energy that can be used by the electric machines 156. The traction battery 150 typically provides a high-voltage direct current (DC) output from one or more battery cell arrays, sometimes referred to as battery cell stacks, within the traction battery. The battery cell arrays may include one or more battery cells as described above.

The battery cells, such as a prismatic, pouch, cylindrical, or any other type of cell, convert stored chemical energy to electrical energy. The cells may include a housing, a positive electrode (cathode) and a negative electrode (anode). A solid-state electrolyte may allow ions to move between the anode and cathode during discharge, and then return during recharge as described above. Terminals may allow current to flow out of the cell for use by the vehicle.

Different battery pack configurations may be available to address individual vehicle variables including packaging constraints and power requirements. The battery cells may be thermally regulated with a thermal management system. Examples of thermal management systems include air cooling systems, liquid cooling systems, and a combination of air and liquid systems.

The traction battery 150 may be electrically connected to one or more power-electronics modules 162 through one or more contactors (not shown). The one or more contactors isolate the traction battery 150 from other components when opened and connect the traction battery to other components when closed. The power-electronics module 162 may be electrically connected to the electric machines 156 and may provide the ability to bi-directionally transfer electrical energy between the traction battery 150 and the electric machines 156. For example, the traction battery 150 may provide a DC voltage while the electric machines 156 may require a three-phase alternating current (AC) voltage to function. The power-electronics module 162 may convert the DC voltage to a three-phase AC voltage as required by the electric machines. In a regenerative mode, the power electronics module 162 may convert the three-phase AC voltage from the electric machines 156 acting as generators to the DC voltage required by the traction battery 150. The description herein is equally applicable to a fully electric vehicle. In a fully electric vehicle, the hybrid transmission 158 may be a gear box connected to an electric machine(s) 156 and the engine 18 is not present.

In addition to providing energy for propulsion, the traction battery 150 may provide energy for other vehicle electrical systems. A typical system may include a DC/DC converter module 164 that converts the high-voltage DC output of the traction battery 150 to a low-voltage DC supply that is compatible with other vehicle components. Other high-voltage loads, such as compressors and electric heaters, may be connected directly to the high-voltage supply without the use of a DC/DC converter module 164. In a typical vehicle, the low-voltage systems are electrically connected to an auxiliary battery 168 (e.g., a 12-volt battery).

A battery energy control module (BECM) 166 may be in communication with the traction battery 150. The BECM 166 may act as a controller for the traction battery 150 and may also include an electronic monitoring system that manages temperature and charge state of each of the battery cells. The traction battery 150 may have temperature sensors. The temperature sensors may be in communication with the BECM 166 to provide temperature data regarding the traction battery 24.

The vehicle 152 may be recharged by a charging station connected to an external power source 176. The external power source 176 may be electrically connected to electric vehicle supply equipment (EVSE) 178. The external power source 176 may provide DC or AC electric power to the EVSE 178. The EVSE 178 may have a charge connector 174 for plugging into a charge port 172 of the vehicle 152. The charge port 172 may be any type of port configured to transfer power from the EVSE 178 to the vehicle 152. The charge port 172 may be electrically connected to a charger or on-board power conversion module 170. The power conversion module 170 may condition the power supplied from the EVSE 178 to provide the proper voltage and current levels to the traction battery 150. The power conversion module 170 may interface with the EVSE 178 to coordinate the delivery of power to the vehicle 152. The EVSE connector 174 may have pins that mate with corresponding recesses of the charge port 172.

The various components discussed may have one or more controllers to control and monitor the operation of the components. The controllers, such as the BECM 33 and others, may communicate via a serial bus (e.g., Controller Area Network (CAN)) or via dedicated electrical conduits. The controller generally includes any number of microprocessors, ASICs, ICs, memory (e.g., FLASH, ROM, RAM, EPROM and/or EEPROM) and software code to co-act with one another to perform a series of operations. The controller also includes predetermined data, or “look up tables” that are based on calculations and test data, and are stored within the memory. The controller may communicate with other vehicle systems and controllers over one or more wired or wireless vehicle connections using common bus protocols (e.g., CAN and LIN). Used herein, reference to “a controller” refers to one or more controllers.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A solid-state battery cell comprising:
an outer case; and
one or more mono-cells disposed in the case, the mono-cell including
a cathode,
an anode,
a solid-state electrolyte sandwiched between the cathode and the anode, and
a current collector associated with the one of a cathode or anode, the current collector including a plate of shape-memory alloy disposed against an outer side of the one of the cathode or anode, wherein the plate of shape-memory alloy is configured to expand or contract in thickness responsive to a change in pressure within an interior of the outer case.

2. The solid-state battery cell of claim 1, wherein the plate of shape-memory alloy is configured to expand in thickness responsive to a decrease in the pressure within the interior of the outer case.

3. The solid-state battery cell of claim 1, wherein the current collector, due to the shape-memory alloy, is configured to contract in thickness responsive to an increase in the pressure within an interior of the outer case.

4. The solid-state battery cell of claim 1, wherein the mono-cell further includes a second current collector associated with the other of the cathode or the anode and including a second plate of shape-memory alloy disposed against an outer side of the other of the cathode or the anode, wherein the second plate of shape-memory alloy is configured to expand or contract in thickness responsive to a change in pressure within the interior of the outer case.

5. The solid-state battery cell of claim 4, wherein the plate and the second plate are different shape-memory alloys.

6. The solid-state battery cell of claim 4, wherein the plate and the second plate are formed of a same shape-memory alloy.

7. A traction battery comprising:
a plurality of solid-state-battery cells arranged in a stack;
a pair of endplates engaging with opposing ends of the stack and configured to generate a predetermined magnitude of stack pressure in the stack; and
a plate of shape-memory alloy disposed in the stack, wherein the plate of shape-memory alloy is configured to expand or contract in thickness responsive to volume changes within the battery cells to maintain the stack pressure within a range of the predetermined magnitude.

8. The traction battery of claim 7, wherein the plate includes opposing major sides and one of the major sides is disposed against one of the battery cells.

9. The traction battery of claim 8, the other of the major sides is disposed against another of the battery cells.

10. The traction battery of claim 8, the other of the major sides is disposed against one of the endplates.

11. The traction battery of claim 7, wherein the plate of shape-memory alloy is disposed within an outer case of one of the battery cells.

12. The traction battery of claim 11, wherein the plate of shape-memory alloy is a current collector of the one of the battery cells.

13. The traction battery of claim 7 further comprising a second plate of shape-memory alloy disposed in the stack, wherein the second plate of shape-memory alloy is configured to expand or contract in thickness responsive to the volume changes within the battery cells to maintain the stack pressure within a range of the predetermined magnitude.

14. The traction battery of claim 7, wherein the range is predetermined.

15. The traction battery of claim 7, wherein the plate of shape-memory alloy is configured to expand in thickness responsive to the volume change decreasing.

16. The traction battery of claim 15, wherein the plate of shape-memory alloy is configured to contract in thickness responsive to the volume change increasing.

17. The traction battery of claim 7, wherein the shape-memory alloy includes at least one of NiTi, Nitinol, Ag—Cd, Au—Cd, Cu-AI-Ni Cu—Sn, Cu—Zn, In—Ni-AI, Ni—Ti, Fe—Pt, Mn—Cu, Fe—Mn—Si, and CuZnAl.

18. A battery array comprising:
a plurality of battery cells arranged in a stack and each including an anode, a cathode, and a solid-state electrode;
a pair of endplates configured to compress the stack to a predetermined stack pressure; and
a plate of shape-memory alloy disposed in the stack and configured to expand or contract responsive to a volume change of the anode, the cathode, or both to maintain the predetermined stack pressure within a predetermined range of the predetermined stack pressure.

19. The battery array of claim 18, wherein the plate of shape-memory alloy is configured to expand responsive to the volume of the anode decreasing.

20. The battery array of claim 18, wherein the plate of shape-memory alloy is configured to contract responsive to the volume of the anode increasing.
